(19) United States
(12) Patent Application Publication
(10) Pub. No.: US 2002/0184146 A1
(43) Pub. Date: Dec. 5, 2002

(54) Non-pay customer retention method

(76) Inventor: Raphael M. Segler, Brighton, MI (US)

Correspondence Address: William M. Hanlon, Jr., Young & Basile, P.C., Suite 624, 3001 West Big Beaver Road, Troy, MI, 48084, US

(21) Appl. No.: 09/870,364

(22) Filed: May 30, 2001

(51) Int. Cl. G06F 17/60

(52) U.S. Cl. 705/40; 705/7

(57) ABSTRACT

A method for retaining a customer of a service provider, such as a cable company. The method includes the steps of receiving information from the provider regarding the customer; performing a first visit to a customer location; providing a warning for the customer if it is not at the location at the time of the first visit; and performing a second visit to the location. If at first or second visit the customer pays an owed amount, the services are not discontinued. If, however, the customer is not at the location at the second visit, or the customer indicates a desire to terminate services at either visit, the services are discontinued and the customer is provided a notice informing it how to reconnect to the services. The warning and the notice preferably include personalized messages.

### BACKGROUND OF THE INVENTION

1. Field of the Invention

The invention relates to the retention of customers of a service provider to a customer's home, such as a cable company.

2. Description of the Related Art

In service industries that provide services to a customer location, such as the cable industry, customer non-payment of bills presents a multitude of problems. Upon non-payment, a service person is typically sent to the house to discontinue the services. The service person attempts to initiate personal contact with the customer and disconnects the customer if they are not at the house at the time of the visit. Many people are not home at the time of the service call, and services are thus discontinued even if the customer would have paid if they had been home.

After the discontinuation of services, if the customer wants to restart the services, he or she must contact the provider to reconnect the house to the services. This necessarily entails another visit from the service person and results in lost revenue during the intervening period of time. Further, if the customer has any equipment owned by the company, such as a converter for cable television, a follow up visit may be required to retrieve the equipment. These multiple visits result in the loss of productive time for the employee or employees that must disconnect and reconnect the customers. The customer retention rate, i.e., the number of customers that continue to receive services after the service call, is extremely low, resulting in the loss of future sales to the customer.

### SUMMARY OF THE INVENTION

The present invention is a method for retaining a customer of a service provider that minimizes the number of follow-up visits to a customer location after a customer's services are discontinued. Specifically, the method comprises the steps of: receiving information from the service provider regarding the customer; performing a first visit to a customer location; providing a warning to the customer if the customer is not at the customer location at a time of the first visit; and performing a second visit to the customer location.

Preferably, the warning is a note placed on the door knob of the location including a first personalized message.

One aspect of the invention further comprises the step of disconnecting the customer location from the service provider if the customer does not pay an owed amount at the first visit. This aspect can include the step of reconnecting the customer location to the service provider at the second visit if the customer pays an owed amount after the first visit. This aspect can also include the step of collecting any equipment owned by the service provider at the customer location.

Another aspect of the present invention further comprises the step of disconnecting the customer location from the service provider if the customer does not pay an owed amount at the second visit. This aspect can include the step of reconnecting the customer location to the service provider at a third visit if the customer pays the owed amount after the second visit. This aspect can also include the step of collecting any equipment owned by the service provider at the customer location.

The aspect including the step of disconnecting the customer location from the service provider if the customer does not pay an owed amount at the second visit can also include the step of providing a disconnection notice to the customer at the second visit. Preferably, the disconnection notice includes a second personalized message.

Another aspect of the invention further comprises the step of providing a disconnection notice to the customer at the second visit. In this aspect, the disconnection notice can be a note placed on a door knob of the location. The disconnection notice can also provide a second personalized message.

In yet another aspect of the invention, the step of receiving information from the service provider regarding the customer comprises the step of receiving a work order for each customer location, each work order including an owed amount.

In one aspect of the invention, the step of performing a first visit to a customer location further comprises the steps of checking for a presence of the customer at the customer location; and asking the customer to pay an owed amount if the customer is present.

The step of performing a second visit to the customer location can further comprise the steps of checking for a presence of the customer at the customer location; and asking the customer to pay an owed amount if the customer is present. This aspect of the invention can further comprise the step of disconnecting the customer location from the service provider if the customer does not pay the owed amount at the second visit.

Another aspect of the invention further comprises the step of updating a work order for the customer location after the step of performing the first visit.

Yet another aspect of the invention further comprises the step of updating a work order for the customer location after the step of performing the second visit.

Thus, the invention is a customer retention method minimizing the number of follow-up visits to a customer after its services are discontinued that also maximizes the number of retained customers, which customers would otherwise have services discontinued for non-payment.

### BRIEF DESCRIPTION OF THE DRAWING

The various features, advantages and other uses of the present invention will become more apparent by referring to the following detailed description and drawing in which:

FIG. 1 is a block diagram of the non-pay customer retention method of the present invention;

FIG. 2 is a sample work order provided to the retention specialist;

FIG. 3 is a sample warning note used after the first visit of the specialist suitable for placement on a door knob at the customer's location;

FIG. 4 is a pictorial representation of sample visit folders for use in the present invention;

FIG. 5 is a pictorial representation of sample results folders for use in the present invention; and

FIG. 6 is a sample disconnection note used after the second visit by the specialist suitable for placement on a door knob of the customer's location.

### DETAILED DESCRIPTION

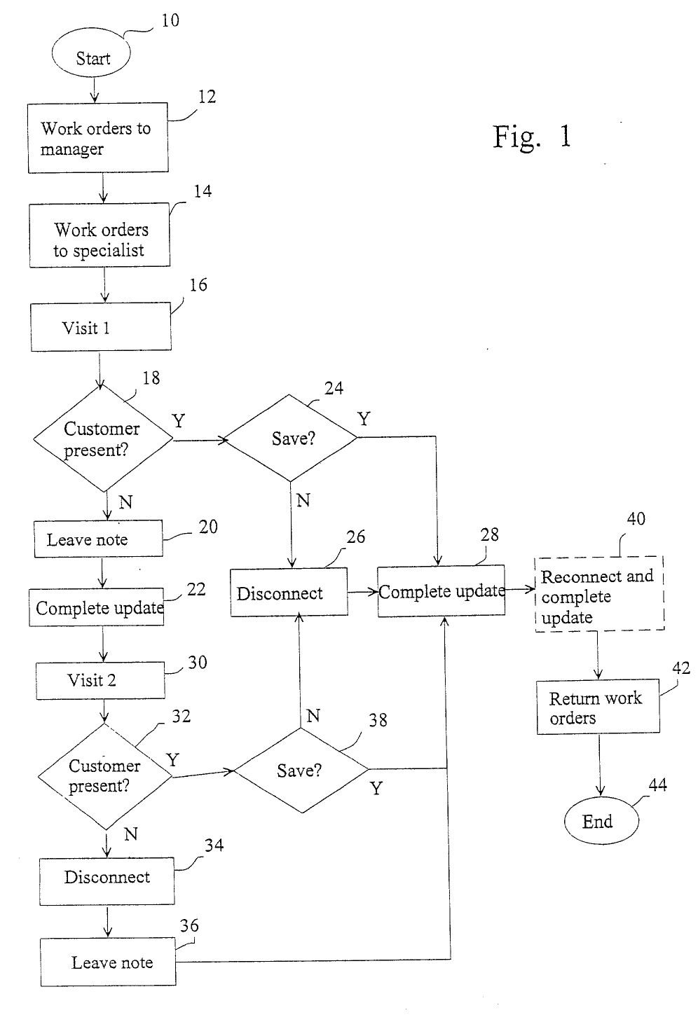

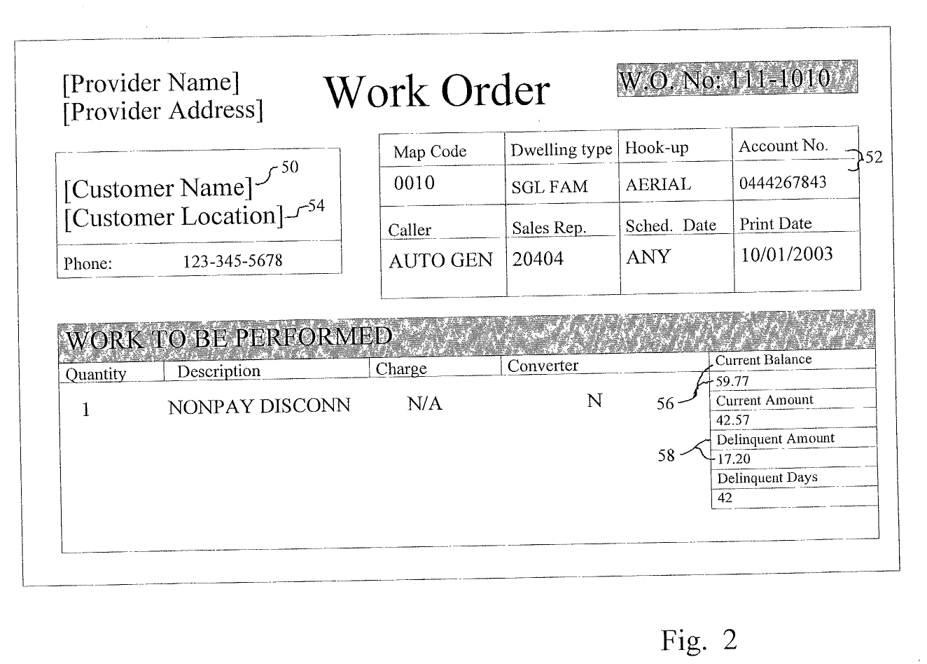

The non-pay customer retention method is shown in the drawing in reference to FIGS. 1-6. In FIG. 1, the retention method starts at step 10 and advances to step 12, where work orders are sent from the service provider and received by a manager implementing the retention method. The service provider can be an electric, cable, telephone or gas company or any other company that provides services to the home. The work orders can be typical work orders prepared by the billing department of a service provider, such as the work order shown in FIG. 2. While the work order generally shows many details of the customer account, only the customer account number 52, customer address or location 54, and the owed amount 56 to be paid to prevent the discontinuation of services, typically the balance owed, are the most useful in the retention method. Preferably, the customer name 50 is also provided to the specialist to assist in personal contact. If a minimum amount due 58 is different from the owed amount 56, the amount due 58 can also be provided. The work orders are transmitted to the manager by various means. For example, the billing department can print the work orders for hand delivery to the manager. Alternatively, the work orders can be sent via facsimile, overnight mail or electronic mail.

Returning now to FIG. 1, in step 12, the manager receives the work orders, counts them, and determines the number of retention specialists needed. The manager determines the number of retention specialists needed depending upon the number of work orders received, the number of days in the work period and the number of work orders that can be completed on each work day of the work period. The number of work orders that can be completed in a day depends upon the geographic area to be covered, the length of the work day and the complexity of the service provided. By example to the cable industry, a retention specialist can visit from about 60 to 75 customers in a day in a suburban service area. In a rural area, that number drops to 50 to about 60 customers a day.

After the manager determines how many retention specialists are needed, the work orders are divided among the specialists in step 14 according to the number of customers and other factors. For example, the manager can divide the work orders by geographic service areas, then by number of customers. Thus, more than one specialist can service a dense area. In a case where more than one service provider is using the retention method, the manager can divide the work orders by provider, then group the customers of the providers by geographic area. Thus, one retention specialist can represent more than one provider in a geographic service area. The manager provides the name and cellular telephone number of each specialist to the service provider, along with a list of which work orders the specialist has received. Although the manager can divide the work orders among any number of retention specialists in step 14, the remainder of the steps of the retention method show only the activities of one specialist for simplicity. Each specialist performs the same steps.

After a retention specialist receives the work orders in step 14, the specialist preferably organizes the work orders into a route. The route represents the most efficient way of visiting all of the customers in that group of work orders. Arranging the route can be done in a number of different ways. One way is through the use of a map. The specialist marks the map with a symbol such as an “X” or an underline to indicate each customer location 54 specified in the work orders. Then, the specialist arranges the work orders in a route from closest to the starting point to closest to the ending point. Of course, the starting and ending points of a route can be the same, resulting in a roughly circular route.

In step 16, the specialist performs a first visit on a customer 50 at the customer location 54. Then, an query is performed in step 18 as to whether the customer 50 is present at the location 54. Typically, this involves knocking on the door or ringing a doorbell at the location 54. If the customer is not present for personal contact in step 18, then the retention specialist leaves a warning note in step 20, indicating the need to pay the owed amount 56 or the minimum amount due 58.

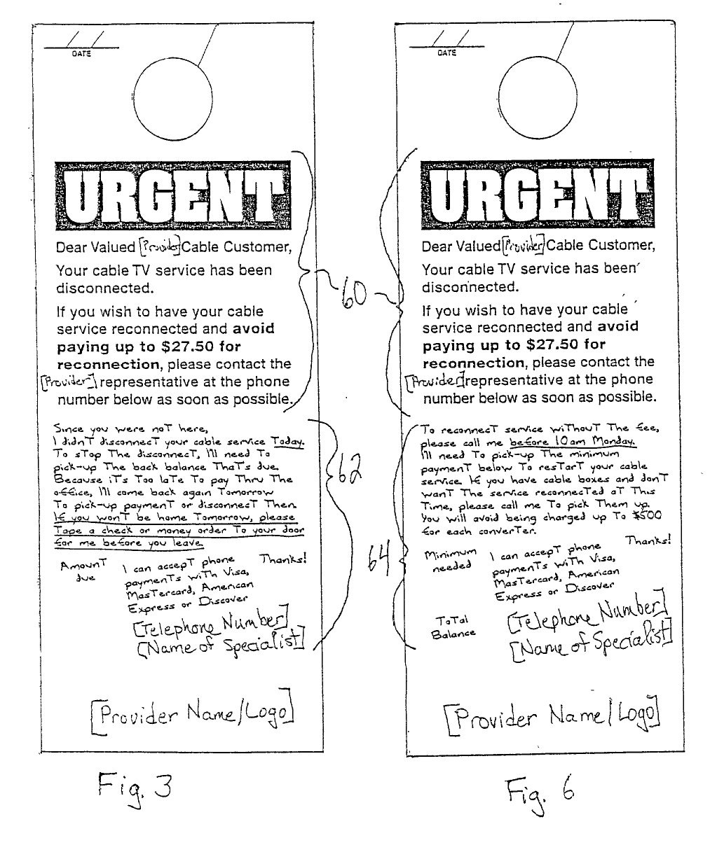

FIG. 3 shows one example of a warning note that is suitable for placement on a door knob at the customer location 54 in step 20. The warning note of FIG. 3 incorporates the standard notice 60 usually provided to a cable television customer upon their service call upon the customer. However, the warning note provided by the specialist also incorporates a personal message 62 telling the customer 50 how to avoid discontinuation of services by paying the owed amount 56 to the specialist upon his/her return visit on another day, in this case the next day. The personal message 62 also provides a contact to pay by telephone. While the personal message 62 on the warning note here does not include any provision for the customer to pay only the minimum amount due 58, such an option could be incorporated. Further, the personal message 62 does not include any mention of the pick up of provider-owned equipment in the event of disconnection, but arrangements for such a pick up can easily be included.

Returning now to FIG. 1, the retention specialist, as mentioned, leaves the warning note in step 20 if the customer 50 is not at the location 54 at the time of the first visit 16. Then, the work orders are updated to reflect the results of the visit in step 22. This can be done in a number of ways. For example, the specialist can record the time and date of the visit and the fact that no one was there by writing it directly on the work order. Alternately, the specialist can maintain a log with the visit time, date and outcome by the customer's account number 52 or location 54. Preferably, completing the update of the work orders in step 22 also reminds the specialist of the need to return on the subsequent day listed on the warning note left in step 20.

One way in which this reminder can be accomplished in step 22 is to set up visit folders such as the folders shown in FIG. 5. By example to FIG. 5, if the first visit in step 16 is on a Friday and the customer 50 is not at the location 54 as determined in step 18, the specialist leaves the warning note, preferably marks the work order with the visit details and files the work order under the visit folder labeled with the promised return day, in this case the visit folder marked “Saturday.” Although described in reference to paper work orders and physical file folders, updating the work orders to reflect the results of the visit in step 22, along with updating the work orders in subsequent steps described herein, can be performed with electronic work orders by including a note in the file and saving the file in a labeled subdirectory in computer memory.

Returning now to step 18, if the customer 50 is at the location 54 at the time of the first visit, then the specialist initiates customer contact in step 24 to determine whether the customer can be saved for the service provider or not. If the customer is no longer interested in receiving the service in step 24, then the specialist disconnects the service in step 26, if possible, and attempts to retrieve any service provider-owned equipment at the customer location 54. Although the retention method involves disconnecting the customer 50, under some circumstances the service provider may not want the specialist to disconnect the customer 50. If the provider so indicates to the specialist, the step of disconnecting the customer does not occur even if the customer 50 indicates it no longer wants service in step 24.

If it is clear that the customer location 54 no longer has a customer 50 in residence on the first visit in step 16, such as when a business has closed, the specialist can skip initiating customer contact in step 24 and proceed immediately to disconnecting the service in step 26.

After the step 26 of disconnecting the customer 50, the retention method then advances to step 28 where the specialist completes an update of the work order. Specifically, the specialist records the customer's decision, preferably writing it directly on the work order along with the other details of the visit, and retains the work order for later submission of all of the completed work orders to the manager in step 42 at the end of the work period, to be discussed hereinafter. Completing the update of the work order in step 28 can also involve other tasks, such as maintaining a log of service provider-owned equipment retrieved at the customer locations.

As mentioned, in step 28 the specialist retains the work order for later submission to the manager. One efficient way of performing this task is to file the work order in one of a number of results folders such as those shown in FIG. 5. The results folders are preferably categorized according to the result reached with the customer 50 after the preceding visit or call. As previously described, if the customer 50 is at the location 54 at the time of the first visit in step 18, and is no longer interested in receiving the service in step 24, then the specialist disconnects the service in step 26. In step 28, the specialist, after recording the decision on the work order, can file the work order in the results folder labeled “No save/Disconnect” shown in FIG. 5. If for any reason the disconnect is not possible, the specialist can file the work order in the results folder labeled “No save/No disconnect.”

More results folders showing specific details of the circumstances surrounding the visit or call can also be provided. Although not shown in FIG. 5, a results folder can include a label, such as “No save/Home/Disconnect” or “No save/Home/No disconnect,” indicating that the customer was home and was not saved. This more readily distinguishes these circumstances from those after the second visit in step 30, to be discussed hereinafter, where the customer 50 is not home and is not saved. As another example, the reason for failure can be included on a labeled results folder. If the customer 50 indicates that another service provider is now providing the services, the work order can be filed in a results folder labeled “No save/Competition/No disconnect” and “No save/Competition/Disconnect,” whichever is relevant. In another refinement, if the customer location 54 no longer has a customer 50 in residence at the time of the first visit, as previously discussed, the work order can be filed in a results folder labeled “Vacant & moved/Disconnect” or “Vacant & moved/No disconnect.” A result folder can also be included that stores the work orders for customers that the service provider does not want disconnected, such as for a commercial customer. Thus, a results folder labeled “No save/Commercial/No disconnect” may be appropriate.

Returning now to step 24 in FIG. 1, if the customer 50 is at the location 54 and would like to keep their service, then the specialist collects either the owed amount 56 or the minimum amount due 58 and updates the work order in step 28. Completing the update of the work order in step 28 involves the same activities as previously described, namely that the specialist records the customer decision, preferably on the work order, then retains the work order for later submission to the manager. Preferably, the work order is retained by filing it in a results folder labeled “Saves” as shown in FIG. 5. Completing the update of the work order in step 28 can also involve additional tasks. For example, to assist in the later return of the work orders, the amount of money collected and the account number 52 can be recorded on one form for summarizing payments by check or cash, while another form can summarize the amount of money collected and the account number 52, along with credit card information, for payments made with credit cards.

In one aspect of the retention method, completing the update of the work orders in step 28 involves reporting the retained customer or “save” in step 24 to the service provider prior to the return of the work orders to the manager at the end of the work period, which occurs later in the method in step 42. This early reporting provides the benefit to the customer 50 and the service provider that the service provider knows of the change in status of the customer 50 at an earlier time than the end of the work period. Thus, the service provider can make a notation in the customer's file to either prevent the denial of additional services requested by the customer 50 during the time after the payment but prior to the end of the work period, or otherwise re-authorizing services to the customer 50. A re-authorization may be needed where the customer had been previously de-authorized, such as the situation where an addressable converter for a cable service is de-authorized prior to the visit by the specialist. The specialist can report the save at any time prior to the end of the work period, such as immediately after the save, after several saves have been collected during the route, or at the end of a work day. One efficient way of reporting the save is to file the work order in a results folder labeled “Saves to call in.” Then, when several are collected, such as four or five, the specialist makes one call reporting all work orders in the results folder. Finally, the specialist removes the work orders called in the results folder labeled “Saves to call in” and retains the them in the results folder labeled “Saves” for later submission to the manager.

In most circumstances the customer 50 wishing to maintain the service in step 24 pays the specialist, who completes the update of the results in step 28. Optionally, the retention method provides that the specialist can make a return visit at the customer's request if, for example, the customer 50 wishes to maintain the service but cannot pay the owed amount 56 or the minimum amount due 58 at the time of the specialist's visit. In that case, the specialist creates a reminder of the return visit such as described in reference to step 22. Specifically, the specialist notes the return day on the work order and preferably file it in a visit folder, such as one shown in FIG. 5, labeled with the return day. By example, if the first visit in step 16 is on a Friday and the customer 50 wants to retain the service and requests in step 24 that the specialist return to the location 54 on Sunday, the specialist marks the work order with the visit details and files the work order under the visit folder labeled “Sunday.” The return visit can be any day prior to the end of the work period, including later in the same day as the first visit.

The specialist performs the first visit and the subsequent steps previously described, steps 16 through 28, for each work order received in step 14. The specialist updates each work order with the result of the first visit in either step 22 or step 28. Preferably, this updating includes filing each work order in an appropriately labeled visit folder or results folder. When filing the work orders, the specialist preferably keeps them in the route order set up in step 14 to facilitate return visits. Upon completion of the steps for each of the customers, the retention method proceeds to step 30, which preferably occurs on the next work day but can occur at any time prior to the end of the work period. On this work day, Saturday, by example, the specialist performs the second or return visit upon all of the customers not present in step 20 and the customers who requested a return visit on Saturday in step 24.

The second visit in step 30 begins with a query by the specialist in step 32 as to whether the customer 50 is at the location 54. If the customer is not at the location in step 32 and has not left a check for the owed amount 56 or the minimum amount due 58, the specialist disconnects the service in step 34, if possible and unless the service provider has provided instructions to the contrary. Then, the retention method advances to step 36, where the specialist leaves a disconnection note at the customer location 54.

FIG. 6 shows one example of a disconnection note that is suitable for placement on a door knob at the customer location 54 in step 36. The disconnection note of FIG. 6 includes the standard notice 60 incorporated into the warning note left in step 20. In addition, the disconnection note incorporates a second personal message 64 telling the customer 50 how to reconnect to the services by paying the owed amount 56 or the minimum amount due 58. Specifically, the personal message 64 provides a deadline for the customer 50 to call the specialist to reconnect the service prior to the end of the work period, in this case 10 am on Monday. The second personal message 64 can also include a request that the customer 50 call the specialist to return any provider-owned equipment.

Returning now to FIG. 1, after the specialist leaves the disconnection note at the customer location 54 in step 36, the retention method advances to step 28, where the specialist updates the work order to include the details and result of the visit. As described previously, the specialist would preferably record the customer's decision on the work order and file the work order in one of the results folders. In this case, an appropriately labeled folder is “No save/Disconnect” or “No save/No disconnect,” as shown in FIG. 5. Alternatively, to distinguish the circumstances from those after the first visit in step 18 where the customer 50 was at home and did not wish to receive the service in step 24, results folders labeled “No save/Not home/Disconnect” or “No save/Not home/No disconnect” can be used.

Returning now to step 32, if the customer 50 is at the location 54 at the time of the second visit, the specialist proceeds to query whether the customer wants to continue service in step 38. If the customer does not wish to continue service in step 44, the specialist disconnects the service in step 26, if it is possible and the service provider has not indicated a desire for the service to remain connected. Then, the work order is updated to reflect the result of the second visit in step 28 by the specialist reporting the visit details and retaining the work order for later submission to the manager. In this case, a result folder that can be used to retain the work order is labeled “No save/Disconnect” or “No save/No disconnect,” or the more detailed label “No save/Home/Disconnect,” “No save/Home/No disconnect,” “No save/Competition/Disconnect,” or “No save/Competition/No disconnect” discussed previously. The specialist also attempts to retrieve any provider-owned equipment and records it on a log, if one is being maintained.

Returning now to step 38, if the customer 50 is at the location 54 and would like to keep their service, then the specialist collects either the owed amount 56 or the minimum amount due 58 and updates the work order in step 28 as previously discussed, namely recording the customer decision, preferably on the work order, then retaining the work order for later submission to the manager. To retain the work order, the specialist preferably files it in the results folder labeled “Saves” as shown in FIG. 5. As previously discussed, the specialist can also report the retained customers prior to returning the work orders at the end of the work period. Also, if the specialist is using a particular form to record payments, the payment is recorded on the form.

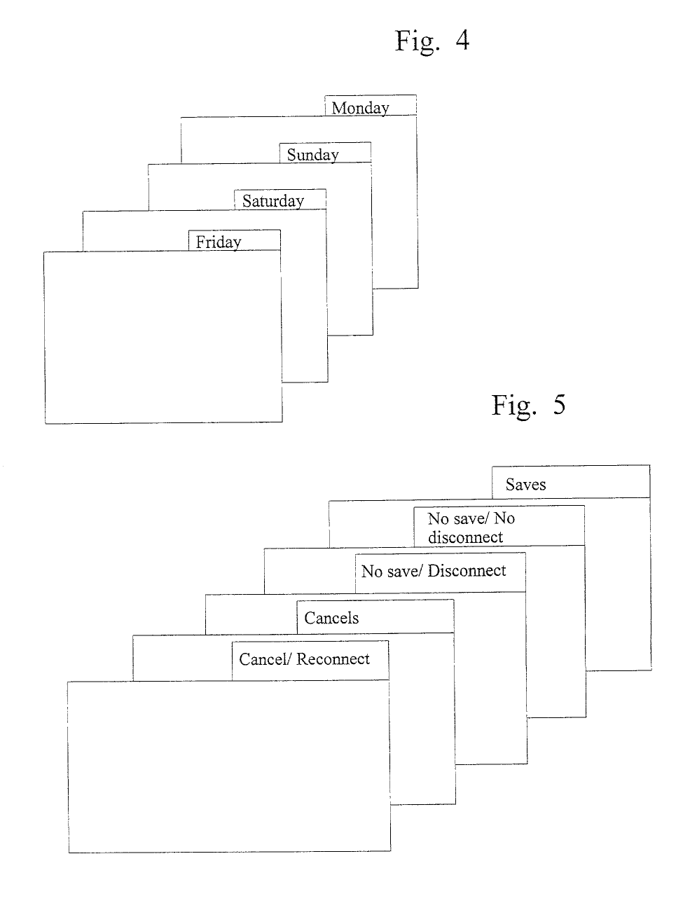

As in step 24, if the customer 50 wants to keep the service, but cannot pay either the owed amount 56 or the minimum amount due 58 at the time of the specialist's visit, then the specialist can make a return visit, as long as the return visit is not after the end of the work period. The specialist creates a reminder of the return visit, preferably by noting the return day on the work order and filing the work order in a visit folder labeled with the return day, as described previously. By example, if the second visit in step 30 is on a Saturday, and the customer 50 wants to retain the service and requests in step 38 that the specialist return to the location 54 on Sunday, the specialist marks the work order with the visit details and files the work order under the visit folder labeled “Sunday,” which is shown in FIG. 4. The specialist then returns for a third visit, performing the retention method as described starting at step 32.

The second visit in step 30, and its subsequent steps, is performed for each of the work orders not designated as saved after the first visit. However, under certain circumstances, either the first or the second visit, or both, will not occur for a particular work order. During any time in this process, the specialist can receive a call from the service provider, canceling one or more work orders. This can occur, for example, if the customer 50 pays the service provider directly for the owed amount 56 or the minimum amount due 58 after the specialist receives the work orders in step 14. If the specialist receives the cancellation any time prior to disconnection in 26 or step 34, then the specialist updates the work order as described with reference to step 28. Specifically, the specialist reports the details of the call, preferably on the work order, and retains the work order for submission to the manager at the end of the work period. One possible way to retain the work order is in a results folder labeled “Cancels,” which is shown in FIG. 5. The specialist can also maintain a separate log of the work orders canceled, along with such details as who canceled the work order and when. Work orders canceled after disconnection are discussed below.

Another situation where the work order may not proceed through the normal first and second visits is when the customer 50 is at the location 54 in step 18 or step 32 and provides some indication, such as a written receipt, that the amount owed 56 or the minimum amount due 58 has previously been remitted to the service provider. This can happen if, for example, the service provider fails to post the payment. The specialist will not continue its visits to the customer location 54, but will skip to step 28 and update the work order. Preferably, the specialist will record the visit details and retain the work order in a results folder labeled “Delays”.

After all of the work orders have been completed at the end of the work period, the retention system advances to step 42, where the completed work orders are returned to the manager. In addition to the completed work orders, money and provider-owned equipment collected from the customers are returned to the manager. If any forms summarizing the results of visits, such as forms reporting the money collected, are prepared by the specialist, these too are returned to the manager. Also in step 42, the manager returns the work orders to the service provider after confirming the receipt of all the orders sent out with the specialist in step 14. By incorporating the results folders into the retention method, providing reconciliation reports to the service provider with the returned work orders is simplified. The retention method then ends at step 44.

Prior to the submission of the work orders from the specialist to the manager in step 42, but subsequent to the update of the work orders in step 28, an optional step 40 in the retention method indicates the ability of the customer 50 to be reconnected after being disconnected prior to the end of the work period. For example, if the customer 50 is disconnected in step 34 after not being at the location 54 at the time of the second visit, the disconnection note left in step 36 informs the customer 50 of its ability to call the specialist by a specified deadline to collect the amount owed and to reconnect the service. If the specialist receives such a call prior to the deadline, the specialist returns to the customer location 54 to reconnect the services in step 40. In addition, the specialist updates the work order to reflect the call. This updating can include filing the work order in the “Saves” results folder. In another example, if the service provider calls the specialist to cancel a work order, but the service for that customer location 54 has already been disconnected, the specialist can return in step 40 to reconnect the service. The work order is also updated, including filing it in, for example, a results folder labeled “Cancel/Reconnect,” which is shown in FIG. 5.

Although the preceding description describes a two-day work period, preferably the retention method of the present invention incorporates a four-day work period for the specialist, extending from Friday morning to Monday afternoon. Thus, the specialist can split the work orders into two sets in step 14, performing the first and second visits on the first set of work orders on Friday and Saturday, respectively, and can perform the first and second visits on the second set of work orders on Sunday and Monday, respectively. Alternately, the specialist can perform the first and second visits on the first set of work orders on Friday and Sunday, respectively, and can perform the first and second visits on the second set of work orders on Saturday and Monday, respectively. Either implementation of the method maximizes the chances of contacting each customer 50 on the first visit 16 or the second visit 30.

Thus, the present invention is a method of retaining customers of a service provider that may otherwise be disconnected from the services for non-payment. The system minimizes the number of return visits required for reconnecting previously disconnected customers and maximizes the number of retained customers.

What is claimed is:

1. A method for retaining a customer of a service provider, comprising the steps of:
receiving information from the service provider regarding the customer;
performing a first visit to a customer location;
providing a warning to the customer if the customer is not at the customer location at a time of the first visit; and
performing a second visit to the customer location.

2. The method of claim 1 wherein the step of providing a warning comprises the step of placing a note on a door knob of the location.

3. The method of claim 1 wherein the step of providing warning comprises the step of providing a first personalized message.

4. The method of claim 1, further comprising the step of:
disconnecting the customer location from the service provider if the customer does not pay an owed amount at the first visit.

5. The method of claim 4, further comprising the step of:
reconnecting the customer location to the service provider at the second visit if the customer pays the owed amount after the first visit.

6. The method of claim 4, further comprising the step of:
collecting any equipment owned by the service provider at the customer location.

7. The method of claim 1, further comprising the step of:
disconnecting the customer location from the service provider if the customer does not pay an owed amount at the second visit.

8. The method of claim 7, further comprising the step of:
reconnecting the customer location to the service provider at a third visit if the customer pays the owed amount after the second visit.

9. The method of claim 7, further comprising the step of:
collecting any equipment owned by the service provider at the customer location.

10. The method of claim 7, further comprising the step of:
providing a disconnection notice to the customer at the second visit.

11. The method of claim 10, wherein the step of providing a disconnection notice comprises the step of providing a second personalized message.

12. The method of claim 1, further comprising the step of:
providing a disconnection notice to the customer at the second visit.

13. The method of claim 12 wherein the step of providing a disconnection notice comprises the step of placing a note on a door knob of the location.

14. The method of claim 12 where in the step of providing a disconnection notice comprises the step of providing a second personalized message.

15. The method of claim 1 wherein the step of receiving information from the service provider regarding the customer comprises the step of:
receiving a work order for each customer location, each work order including an owed amount.

16. The method of claim 1, wherein the step of performing a first visit to a customer location further comprises the steps of:
checking for a presence of the customer at the customer location; and
asking the customer to pay an owed amount if the customer is present.

17. The method of claim 1, wherein the step of performing a second visit to the customer location further comprises the steps of:
checking for a presence of the customer at the customer location; and
asking the customer to pay an owed amount if the customer is present.

18. The method of claim 17, further comprising the step of:
disconnecting the customer location from the service provider if the customer does not pay the owed amount at the second visit.

19. The method of claim 1, further comprising the step of:
updating a work order for the customer location after the step of performing the first visit.

20. The method of claim 1, further comprising the step of:
updating a work order for the customer location after the step of performing the second visit.
